(19) United States
(12) Patent Application Publication
(10) Pub. No.: US 2007/0047898 A1
(43) Pub. Date: Mar. 1, 2007

(54) Precision resonance frequency tuning method for photonic crystal structures

(75) Inventor: Chen-Hsiung Cheng, Westford, MA (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/354,606

(22) Filed: Feb. 15, 2006

Related U.S. Application Data
(60) Provisional application No. 60/712,807, filed on Aug. 31, 2005.

(51) Int. Cl. G02B 6/00

(52) U.S. Cl. 385/147

(57) ABSTRACT

A method for red-tuning the resonance frequency of a photonic crystal structure that includes a plurality of holes, using a near-field scanning optical microscope (NSOM) system. Part of the photonic crystal structure is ablated using the NSOM system to form submicron scale debris on a top surface of the photonic crystal structure. The tip of the NSOM system is used to move a portion of the submicron scale debris across the top surface of the photonic crystal structure to partially fill at least one predetermined hole of the plurality of holes of the photonic crystal structure. The portion of the submicron scale debris partially filling the predetermined hole(s) may be annealed.

### FIELD OF THE INVENTION

The present invention concerns a method for tuning the resonance frequency of photonic crystal structures. In particular, this method may allow for both blue-tuning and red-tuning of previously formed photonic crystal structures.

### BACKGROUND OF THE INVENTION

Precision tuning of the resonance frequency of photonic crystal structures is desired due to the fact that mass production of identical parts cannot easily accommodate individual frequency needs of various applications. Production variation may also desirably be corrected using precision tuning methods.

Blue-tuning of photonic crystal structures using laser ablation is known in the art, for example, see US Published Patent Application 2001/0012149. Intuitively, the general belief is that removal of mass only can produce blue-tuning of resonance frequency on a photonic crystal or similar resonant photonic devices because of the reduction of device volume. It is desirable, however to be able to perform both precision blue-tuning and precision red-tuning of photonic crystal structures.

One significant advantage of being able to do both blue-tuning and red-tuning is that an overshifted resonator may be tuned back and corrected to be useful. For example, overly blue-shifted devices that would otherwise be rejected may be red-shifted back to have the desired resonance frequency, thus increasing production yield. Additionally, the frequency range across which a single photonic crystal structure is tunable may be increased by a method that allows both blue-tuning and red-tuning.

### SUMMARY OF THE INVENTION

An exemplary embodiment of the present invention involves an exemplary method with which laser ablation may be used to remove and also rearrange material of the photonic crystal structure on nanometer scale. Due to this rearrangement, the resonator may be tuned to produce a red shift in its resonance frequency although the laser ablation process still produces net mass loss as well as volume reduction. An alternative exemplary embodiment of the present invention involves the use of laser assisted chemical vapor deposition (LACVD) to achieve a similar result.

An exemplary embodiment of the present invention is a method for red-tuning the resonance frequency of a photonic crystal structure that includes a plurality of holes, using a near-field scanning optical microscope (NSOM) system. Part of the photonic crystal structure is ablated using the NSOM system to form submicron scale debris on a top surface of the photonic crystal structure. The tip of the NSOM system is used to move a portion of the submicron scale debris across the top surface of the photonic crystal structure to partially fill at least one predetermined hole of the plurality of holes of the photonic crystal structure. The portion of the submicron scale debris partially filling the predetermined hole(s) may be annealed. Alternatively, if the ablation site is in the immediate vicinity of the hole(s) to be filled, the partial filling may be performed during ablation by redeposition of the debris within the desired hole(s). In this exemplary embodiment it is noted that annealing may occur during the ablation and redeposition process.

Another exemplary embodiment of the present invention is a method for red-tuning the resonance frequency of a photonic crystal structure that includes a plurality of holes, using a laser assisted chemical vapor deposition (LACVD) system. The photonic crystal structure is placed in a deposition chamber of the LACVD system. A beam spot of the LACVD system is aligned to be incident on a predetermined hole of the photonic crystal structure and a deposition vapor is introduced into the deposition chamber of the LACVD system. Laser radiation of the LACVD system is coupled to the beam spot on the predetermined hole of the photonic crystal structure. The laser radiation induces the deposition vapor to react and deposit material at the beam spot, partially filling the predetermined hole. Alternatively, the resonance frequency of a photonic crystal structure may be red-tuned by using the LACVD system to deposit material on a portion of a defect of the photonic crystal structure to form a hump.

A further exemplary embodiment of the present invention is a method for red-tuning the resonance frequency of a photonic crystal structure that includes a plurality of holes and a defect section, using a near-field scanning optical microscope (NSOM) system. Nano-particles from a reservoir of nano-particles are trapped using the NSOM system. The trapped nano-particles are then placed either: 1) in a predetermined hole of the photonic crystal structure to partially fill the predetermined hole; or 2) on the defect section of the photonic crystal structure to form a hump.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1A is a top view micrograph illustrating an exemplary one dimensional photonic crystal structure that may be used in any of the exemplary methods of the present invention.

FIG. 1B is a top view micrograph illustrating an exemplary one dimensional photonic crystal structure that has been blue-tuned according to an exemplary method of the present invention.

FIG. 1C is a top view micrograph illustrating an exemplary one dimensional photonic crystal structure that has been red-tuned according to an exemplary method of the present invention.

FIG. 2A is a graph of transmission power versus wavelength illustrating the effect of the blue-tuning of the exemplary one dimensional photonic crystal structure of FIG. 1B.

FIG. 2B is a graph of transmission power versus wavelength illustrating the effect of the red-tuning of the exemplary one dimensional photonic crystal structure of FIG. 1C.

FIG. 2C is a graph of transmission power versus wavelength illustrating numerical simulations of exemplary tuning methods of the present invention on an exemplary one dimensional photonic crystal structure.

FIG. 3 is a top view block diagram illustrating tuning methods of the present invention on an exemplary one dimensional photonic crystal structure.

FIG. 4 is a top view micrograph illustrating exemplary results of near-field scanning optical microscope (NSOM) laser ablation hole drilling according to the present invention.

FIG. 5 is a side plan view of an exemplary NSOM laser ablation system configuration according to the present invention.

FIG. 6 is a graph of transmission power versus wavelength illustrating numerical simulations of exemplary red-tuning methods of the present invention on an exemplary one dimensional photonic crystal structure.

FIG. 7A is a top plan drawing illustrating an exemplary red-tuned one dimensional photonic crystal structure formed using an exemplary method of the present invention.

FIG. 7B is a side plan drawing illustrating an exemplary red-tuned one dimensional photonic crystal structure formed using an exemplary method of the present invention.

FIG. 8 is a graph of transmission power versus wavelength illustrating numerical simulations of exemplary blue-tuning methods of the present invention on an exemplary one dimensional photonic crystal structure.

FIG. 9A is a top plan drawing illustrating an exemplary blue-tuned one dimensional photonic crystal structure formed using an exemplary method of the present invention.

FIG. 9B is a top plan drawing illustrating another exemplary blue-tuned one dimensional photonic crystal structure formed using an exemplary method of the present invention.

FIG. 10 is a graph of transmission power versus wavelength illustrating numerical simulations of exemplary blue-tuning methods of the present invention on an exemplary one dimensional photonic crystal structure.

FIG. 11 is a top plan drawing illustrating a further exemplary blue-tuned one dimensional photonic crystal structure formed using an exemplary method of the present invention.

FIG. 12 is a side plan drawing illustrating yet another exemplary red-tuned one dimensional photonic crystal structure formed using an exemplary method of the present invention.

FIG. 13 is a flowchart illustrating an exemplary method of red-tuning a one dimensional photonic crystal structure using an NSOM system according to the present invention.

FIG. 14 is a flowchart illustrating another exemplary method of red-tuning a one dimensional photonic crystal structure using an NSOM system according to the present invention.

FIG. 15 is a flowchart illustrating an exemplary method of red-tuning a one dimensional photonic crystal structure using an LACVD system according to the present invention.

FIG. 16 is a flowchart illustrating another exemplary method of red-tuning a one dimensional photonic crystal structure using an LACVD system according to the present invention.

FIG. 17 is a flowchart illustrating a further exemplary method of red-tuning a one dimensional photonic crystal structure using an NSOM system according to the present invention.

### DETAILED DESCRIPTION OF THE INVENTION

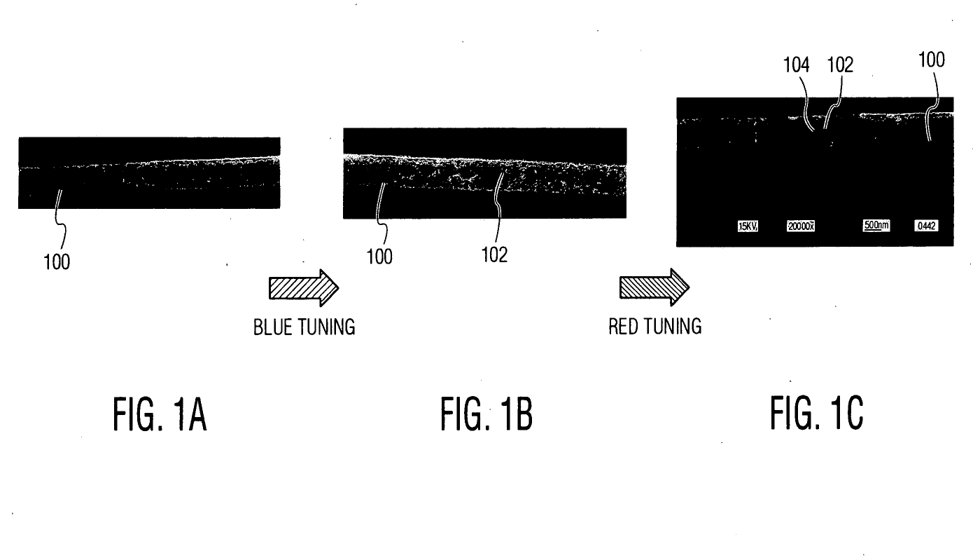

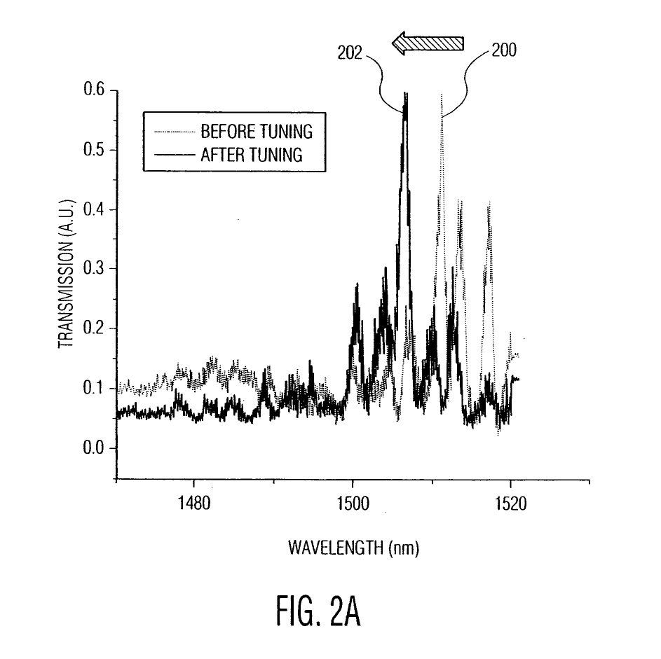

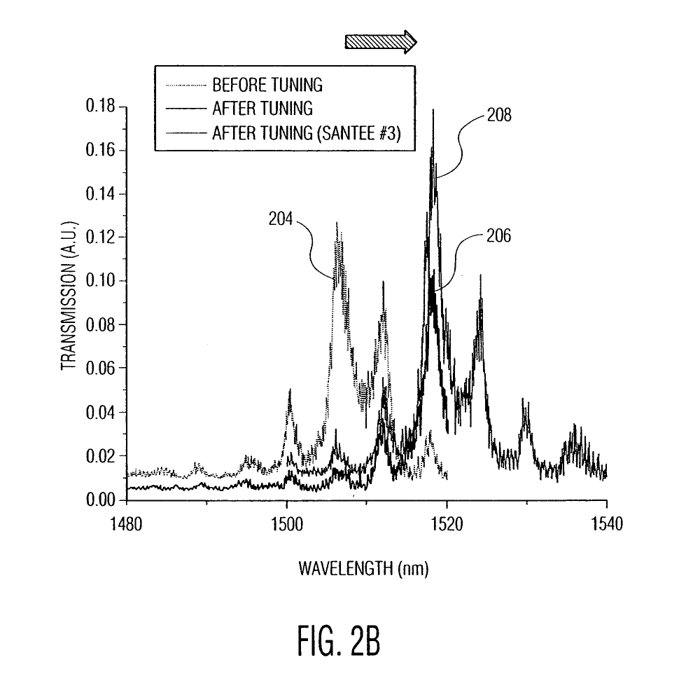

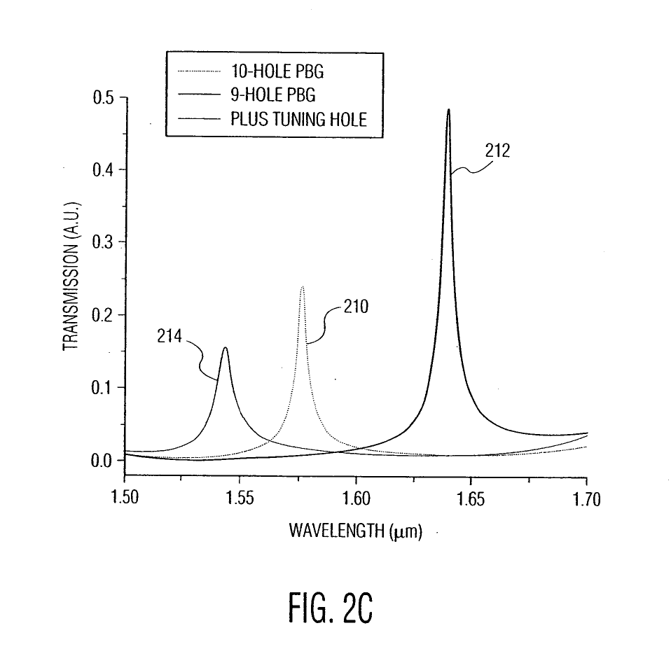

FIGS. 1A-C are photomicrographs of untuned and tuned one-dimensional photonic crystal structures 100. These three exemplary photonic crystal structures and the associated spectra of FIGS. 2A and 2B illustrate exemplary resonance tuning of photonic crystal structures according to the present invention.

FIG. 1A shows exemplary photonic crystal structure 100 before tuning. Transmission spectrum 200 (shown in FIG. 2A), which has a peak at ˜1512 nm, was measured on this exemplary untuned photonic crystal structure. FIG. 1B shows exemplary photonic crystal structure 100 after tuning hole 102 has been formed. FIG. 2A shows that the addition of tuning hole 102 leads to a blue-tuning of transmission spectrum 200 to blue-tuned transmission spectrum 202, which has a peak at ˜1506 nm.

In FIG. 1C, one of the original holes of exemplary photonic crystal structure 100 has been partially filled with debris from the ablation of tuning hole 102, labeled as partially filled hole 104. FIG. 2B illustrates blue-shifted transmission spectrum 204, measured before hole 104 was partially filled, and red-shifted transmission spectra 206 and 208, measured after hole 104 was partially filled. Transmission spectrum 206 was measured using the same apparatus that was used to measure transmission spectra 200, 202, and 204. Because the structure of transmission spectrum 206 clearly extends to longer wavelengths than the initial test apparatus could measure, a second red-shifted transmission spectrum 208 was measured using different test apparatus. As shown in FIG. 2B, transmission spectrum 208 has the same peak resonance wavelength (or frequency) as transmission spectrum 206. The peak resonance wavelength of the photonic crystal structure may be seen in FIG. 2B to have been shifted from ˜1506 nm to ˜1518 nm by partially filling hole 104.

It is noted that, although both transmission spectrum 202 and transmission spectrum 204 were taken after the formation of tuning hole 102, there are differences in the shapes of these spectra. These shape differences may be explained as resulting from slight changes in the structures or coupling during the several days between these measurements. Significantly, however, the peak resonance wavelengths of these two spectra are approximately the same, at least compared to the amount they have been tuned.

FIG. 2C illustrates a numerical simulation of the exemplary tuning of photonic crystal structure 100 shown in FIGS. 1A-C. Simulated spectrum 210 is based on a 10-hole photonic crystal structure with a defect (i.e. a different hole spacing) similar to the untuned photonic crystal structure shown in FIG. 1A. Removing one of the holes next to the defect in the modeled photonic crystal structure leads to simulated spectrum 212 which has a 63 nm red-tuning from simulated spectrum 210. The 9-hole photonic crystal structure used in this simulation represents an idealized version of the red-tuned photonic crystal structure of FIG. 1C. Simulated spectrum 214 illustrates the 33 nm blue-tuning caused by the addition of a tuning hole within the defect of an exemplary 10-hole photonic crystal structure. This structure corresponds to blue-tuned photonic crystal structure 100 as shown in FIG. 1B.

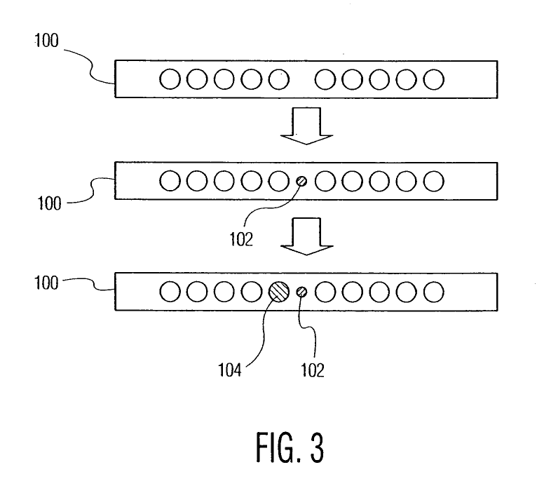

FIG. 3 illustrates an exemplary method for red-tuning the resonance frequency of photonic crystal structure 100, which includes a number of holes (10 in this example). A near-field scanning optical microscope (NSOM) system is used in this exemplary embodiment.

Part of the photonic crystal structure may be ablated using the NSOM system to form tuning hole 102 in the defect of photonic crystal structure 100. This ablation process may desirably form submicron scale debris on a top surface of photonic crystal structure 100. It is noted that the submicron scale debris may be formed by ablating other portions of the surface of photonic crystal structure 100 and that it may be possible to form the desired amount of submicron scale debris without forming a single hole that is large enough (or correctly located) to significantly blue-tune the peak resonance frequency.

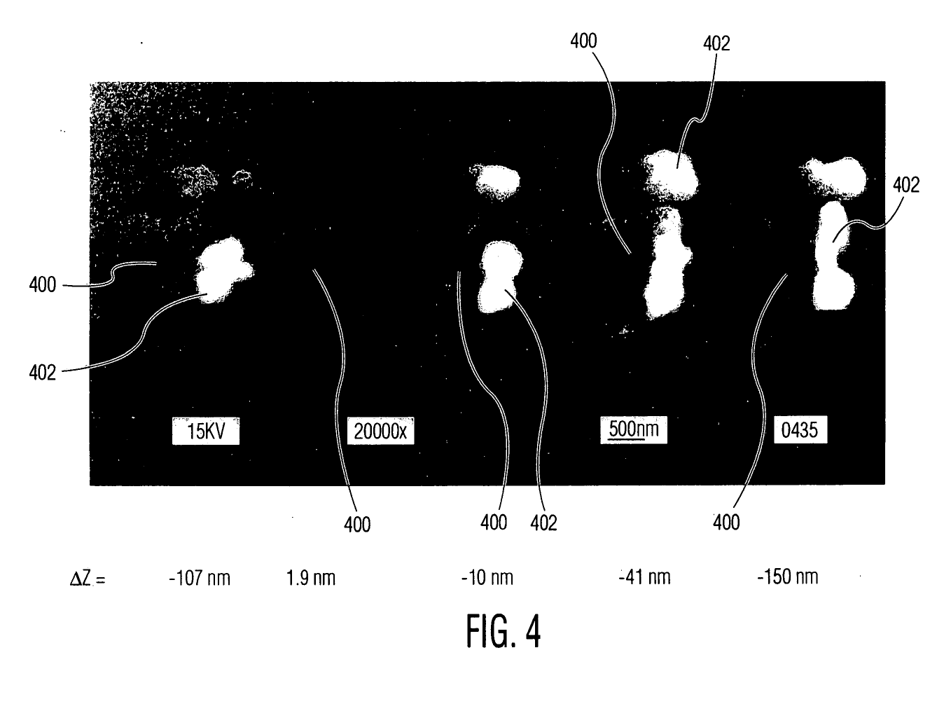

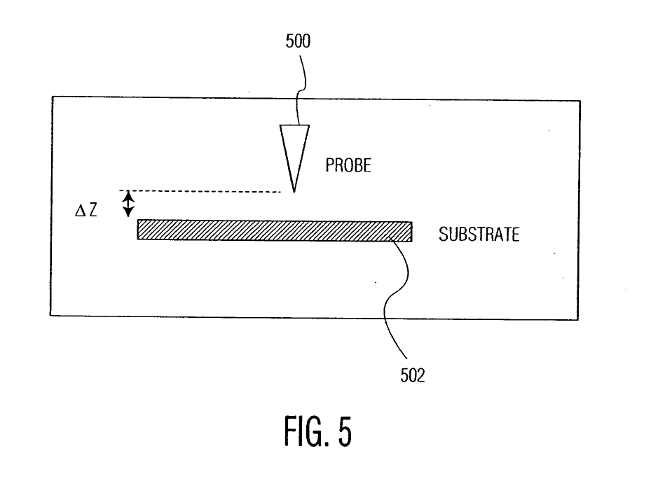

FIG. 4 illustrates submicron scale debris 402 that may be formed on the surface of a substrate due to the laser ablation of holes 400 using an NSOM system. FIG. 5 shows the relationship between probe tip 500 of the NSOM system and substrate 502. In FIG. 4, positive ΔZ reading represents that the NSOM tip is a scaled distance above the surface of the substrate and a negation ΔZ represents a scaled force that the NSOM tip is exerting on the surface of the substrate.

Once the submicron scale debris is formed on the surface of the photonic crystal structure, the tip of the NSOM system may be used to move a portion of the submicron scale debris across the top surface of the photonic crystal structure. This submicron scale debris may be used to partially, or substantially completely, fill at least one predetermined hole of the photonic crystal structure. As shown in FIG. 2B, precision red-tuning of the photonic crystal structure may be achieved using this exemplary method.

Alternatively, the sides of the at least one predetermined hole of the photonic crystal structure may be ablated so that at least a portion of the resulting submicron scale debris may fall into the hole from which it was ablated, partially refilling the predetermined hole(s) to obtain the desired red-tuning of the photonic crystal structure. This method may be performed using a far-field laser ablation system as well as an NSOM system. It is noted that ablation control may be more difficult using far-field laser ablation, however.

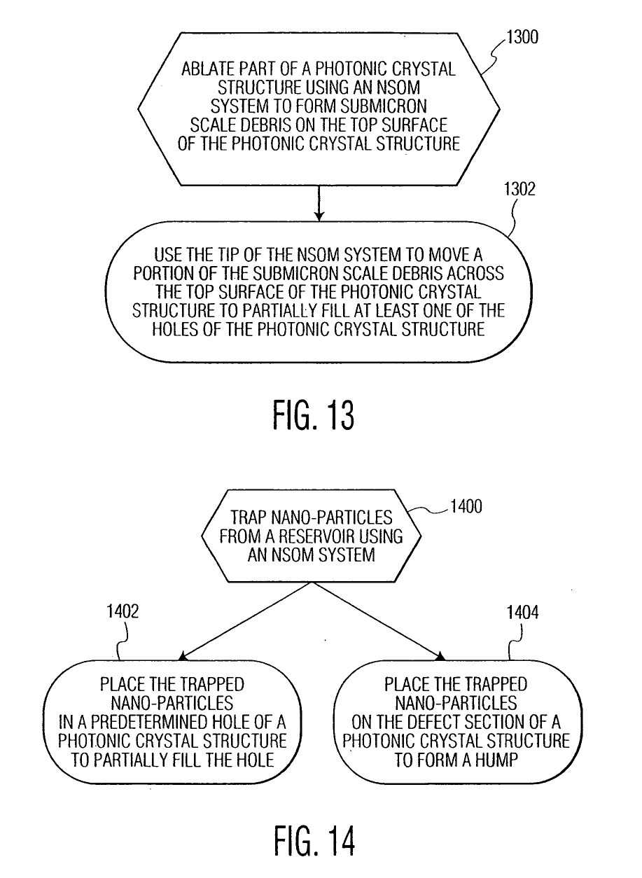

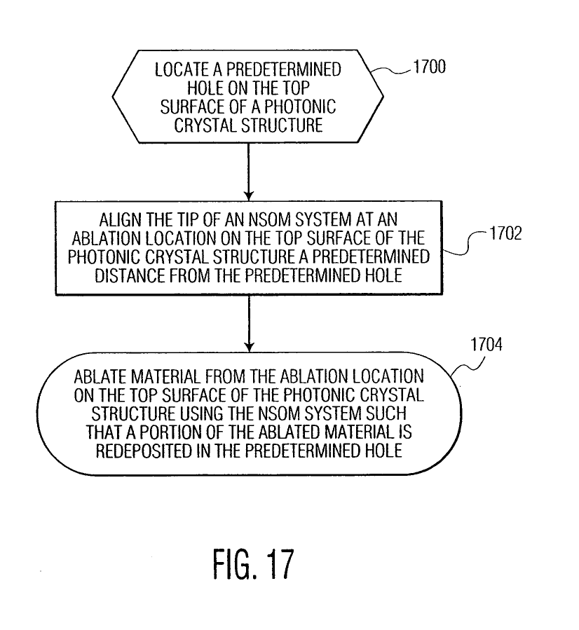

FIGS. 13 and 17 are flowcharts that illustrate exemplary steps for accomplishing these exemplary methods for red-tuning the resonance frequency of photonic crystal structure using an NSOM system.

Referring to FIG. 13, a part of the photonic crystal structure is ablated using the NSOM system to form submicron scale debris on the top surface of the photonic crystal structure, step 1300. As shown in FIG. 4, it may be desirable to contact the tip of the NSOM system on a predetermined location of the top surface of the photonic crystal structure before ablating the surface. Laser pulses are then coupled from the pulsed laser source of the NSOM system through the tip of the NSOM system to ablate the desired part of the photonic crystal structure and leave the submicron scale debris nearby on the surface.

The NSOM tip may be contacted on the predetermined location of the top surface after first locating the predetermined location. The tip of the NSOM system may then be aligned with the predetermined location of the top surface of the photonic crystal structure in a plane approximately parallel to the top surface and the tip of the NSOM system and the top surface of the photonic crystal structure may be brought together along a line substantially normal to the plane until the tip exerts a predetermined force on the predetermined location. One exemplary method of locating the predetermined location of the top surface of the photonic crystal structure is to profile the top surface using the NSOM system. Alternatively, the top surface of the photonic crystal structure may be imaged using an optical camera.

Once the submicron scale debris is formed, the submicron scale debris formed on the top surface of the photonic crystal structure may be located using either the NSOM or an optical camera. The tip of the NSOM system may be used to move a portion of the submicron scale debris across the top surface of the photonic crystal structure to partially fill at least one predetermined hole of the photonic crystal structure, step 1302. The volume of the predetermined hole(s) desired to be filled may desirably be determined. The initial resonance frequency of the photonic crystal structure may be measured and compared to a desired resonance frequency range to determine the amount of red-tuning desired. The volume of the predetermined hole(s) to fill is then determined based on this comparison. It is noted that the predetermined hole(s) may be completely filled by this exemplary process.

The submicron scale debris may be moved by using the NSOM tip to push grains of the submicron scale debris across the top surface of the photonic crystal structure and into one of one or more predetermined holes of the photonic crystal structure.

Alternatively, a tightly focused laser beam may be used to trap nano-particles, such as grains of the submicron scale debris, and move them from place to place. This technique is called optical tweezers. Optical tweezers use light to manipulate microscopic objects as small as a single atom. The radiation pressure from a focused laser beam is able to trap the small particles. In the biological sciences, these instruments have been used to apply forces in the pN-range and to measure displacements in the nm range of objects ranging in size from 10 nm to over 100 mm. The tip of the NSOM system may be aligned with one or more grains of the submicron scale debris. The laser beam from a laser source of the NSOM system may be coupled through the tip of the NSOM system to trap the grain(s) of the submicron scale debris. The trapped grain(s) may then be placed in one of the holes of the photonic crystal structure by moving the tip over the hole and releasing the grain(s) from the laser beam. It is noted that the laser source used in this embodiment of the exemplary method is desirably a CW laser source.

The portion of the submicron scale debris partially filling the predetermined hole(s) of the photonic crystal structure may then be annealed. This annealing step may be accomplished by heating the photonic crystal structure to temperature greater than an annealing temperature for material of the submicron scale debris. The annealing temperature is sufficient to cause the submicron scale debris to bond together somewhat and to also bond with surface of the partially filled hole(s), but is desirably less than the melting point temperature of the material of the photonic crystal structure to prevent damage to the photonic crystal structure during annealing. It is noted that submicron particles may have melting point temperatures less that the melting point temperatures of the same material in a bulk form. Thus, even if the submicron scale debris is formed of the same material of the photonic crystal structure, the annealing temperature may be greater than the melting point temperature of the submicron scale debris.

Alternatively, the portion of the submicron scale debris partially filling the predetermined hole(s) may be irradiated using the pulsed laser source of the NSOM system. This irradiation occurs at an annealing fluence, which is less than the ablation threshold fluence of the material of the submicron scale debris. The irradiation may result in the melting of the submicron scale debris, however.

Once the photonic crystal structure has been red-tuned, the tuned resonance frequency of the photonic crystal structure may be measured and compared to the desired resonance frequency range. If the tuned resonance frequency is greater than the desired resonance frequency range, the photonic crystal structure may be red-tuned further or, if the tuned resonance frequency is less than the desired resonance frequency, the photonic crystal structure may be blue-tuned using a standard blue-tuning technique. These tuning may desirably be continued until the tuned resonance frequency falls within the desired resonance frequency.

FIG. 17 illustrates an alternative method for red-tuning the resonance frequency of a photonic crystal structure that includes a plurality of holes on its top surface, using an NSOM system. The predetermined hole is located as described above in the exemplary method of FIG. 13, on the top surface of the photonic crystal structure, step 1700. The tip of the NSOM system is then aligned at an ablation location on the top surface of the photonic crystal structure a predetermined distance from the predetermined hole, step 1702. As shown in FIG. 4, it may be desirable for the NSOM tip to be placed in contact with the surface of the photonic crystal structure. Also, in the exemplary photomicrograph of FIG. 4, the predetermined distance between the ablation location and the predetermined hole may desirably be on the order of 100 nm. However, this distance may be material dependent and may be determined experimentally for each photonic crystal material.

Material is then desirably ablated from the ablation location on the top surface of the photonic crystal structure using the NSOM system such that a portion of the ablated material is redeposited in the predetermined hole, step 1704. As described above with reference to FIG. 13, the amount of material desired to be redeposited in the hole may be determine based on a comparison of the initial resonance frequency of the photonic crystal structure and a desired resonance frequency range.

The portion of the ablated material redeposited in the predetermined hole may self anneal during the redeposition process or it may be annealed in an additional step once the desired volume of the predetermined hole has been filled.

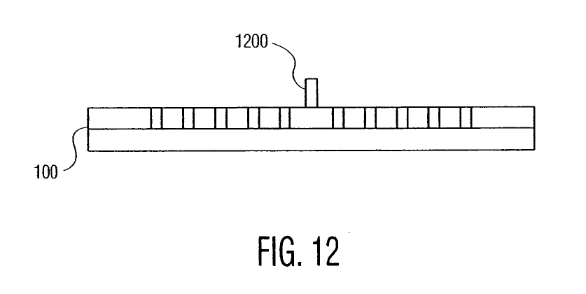

FIG. 12 illustrates another exemplary embodiment of the present invention, using an optical tweezers technique. A pair of exemplary methods for red-tuning the resonance frequency of a photonic crystal structure that includes a plurality of holes and a defect section, using optical tweezers techniques are illustrated in FIG. 14. An NSOM system may be used to “trap” or pickup a nanometer scale particle from a reservoir of nano-particles, step 1400. This trapped nano-particle may be deposited within a predetermined hole of the photonic crystal structure, step 1402, to partially fill the hole and produce the desired red-tuning. Alternatively, trapped nano-particles may be delivered to the defect, step 1404, to form hump 1200. This additional volume at the defect may also produce a red-shift in the peak resonance frequency of the photonic crystal structure. After placement in either step 1402 or 1404, the nano-particles may be annealed to improve adhesion. It is noted that the nano-particles may be formed of the same material as the photonic crystal, but this is not necessary. Filling the predetermined hole or forming a hump out of a material having a different refractive index than the material of the photonic crystal may provide a greater red-tuning range.

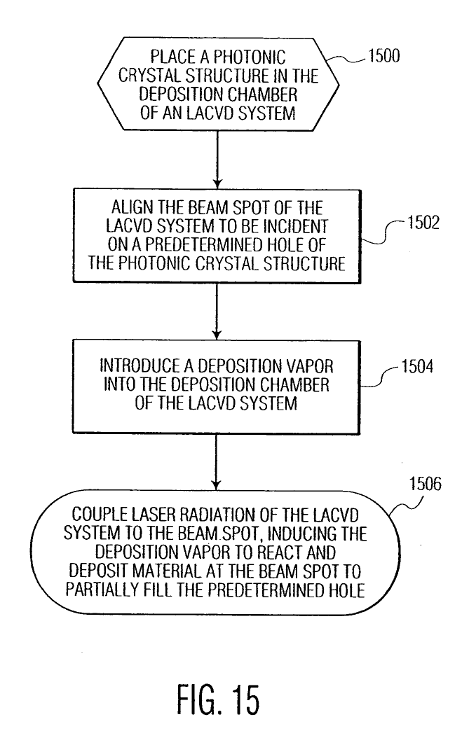

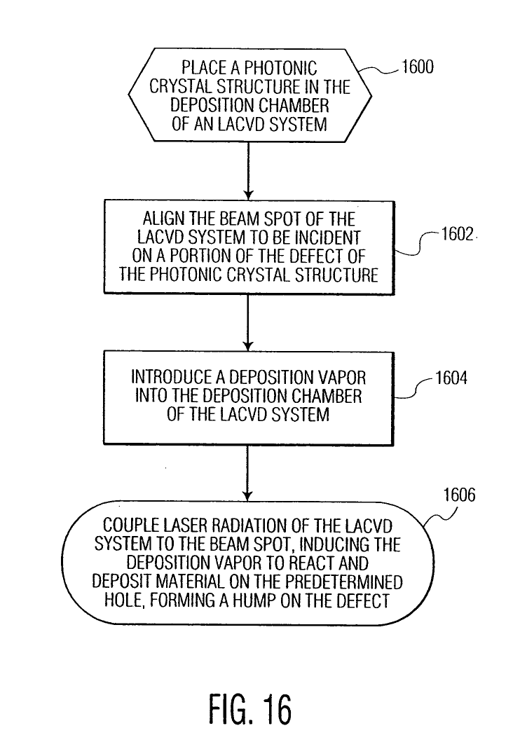

FIGS. 15 and 16 illustrate other exemplary embodiments of the present invention for red-tuning the resonance frequency of a photonic crystal structure that includes a plurality of holes, using a laser assisted chemical vapor deposition (LACVD) system.

In the exemplary method of FIG. 15, the photonic crystal structure is placed in a deposition chamber of the LACVD system, step 1500, and the chamber is evacuated.

The top surface of the photonic crystal structure and the beam spot of the LACVD system on the top surface may be imaged using an optical camera. The location of the predetermined hole of the photonic crystal structure relative to the beam spot of the LACVD system on the top surface of the photonic crystal structure may then be identified. The LACVD system is then adjusted so that the beam spot of the LACVD system is aligned to be incident on the predetermined hole of the photonic crystal structure, step 1502. This alignment procedure is exemplary and is not meant to be limiting. It is contemplated that other methods of aligning the beam spot to be incident on the predetermined hole may be used as well.

It is noted that the beam spot may desirably coincide with the hole to which it is aligned. Alternatively, the beam spot may be smaller than the hole. If the beam spot is smaller than the hole, then the beam spot may be scanned around within the hole during deposition so that material may be deposited throughout the hole.

A deposition vapor, or vapors, is introduced into the deposition chamber of the LACVD system, step 1504. The deposition vapor(s) are selected such that they do not significantly react until they are activated by absorbing energy at the wavelength of the LACVD laser. Once activated by the laser energy, the deposition vapor(s) react to form a solid material that is deposited on the substrate near the location where it was activated by being illuminated with the laser light. This deposition process may allow for the growth of small and precise structures. Although heterostructures may be grown in this way, it may be desirable for the deposition vapor(s) to be chosen such that the deposited material is of the same type as the material of the photonic crystal structure.

Laser radiation from the LACVD system is coupled to the beam spot on the predetermined hole of the photonic crystal structure, inducing the deposition vapor(s) to react and deposit material at the beam spot, step 1506, partially filling the predetermined hole. The amount of laser radiation coupled is based on the amount of material desired to partially, or fully, fill the predetermined hole(s). The laser radiation may be supplied by a continuous wave (CW) laser source or desirably by a pulsed laser source. If the beam spot is smaller than the hole on which it is incident, or if there are two or more predetermined holes to be partially filled, the beam spot may be scanned over the area(s) of the surface of the photonic crystal structure on which deposition is desired.

It is noted that hump 1200 in FIG. 12 may be formed using LACVD as well as illustrated in the exemplary method of FIG. 16.

As in the exemplary method of FIG. 15 described above, the photonic crystal structure is placed in a deposition chamber of the LACVD system, step 1600, and the chamber is evacuated. The LACVD system is then adjusted so that the beam spot of the LACVD system is aligned to be incident on a portion of the defect of the photonic crystal structure, step 1602.

It is noted that the beam spot may desirably coincide with the size and shape of the hump to be formed. Alternatively, the beam spot may be smaller than the desired hump. If the beam spot is smaller than the desired hump, then it may be scanned around within the area of the desired hump during deposition so that the entire hump may be formed.

A deposition vapor, or vapors, are introduced into the deposition chamber of the LACVD system, step 1604. Laser radiation from the LACVD system is coupled to the beam spot on the portion of the defect of the photonic crystal structure where the hump is to be formed, inducing the deposition vapor(s) to react and deposit material at the beam spot, step 1606, to form the desired hump. The amount of laser radiation coupled is based on the area and height of the desired hump. If the beam spot is smaller that the desired hump, the beam spot may be scanned over the area of the surface of the photonic crystal structure on which deposition is desired.

In any of the exemplary methods described above, it may be desirable to anneal the portion of the submicron scale debris partially filling the predetermined hole(s) or forming a hump in the defect. This annealing process may ensure that the submicron scale debris does not become dislodged from the partially filled hole(s) or defect surface over time. Annealing may also improve the homogeneity of the material partially filling the hole(s) or forming the hump, which may improve the quality of the transmission spectrum of the tuned photonic crystal structure.

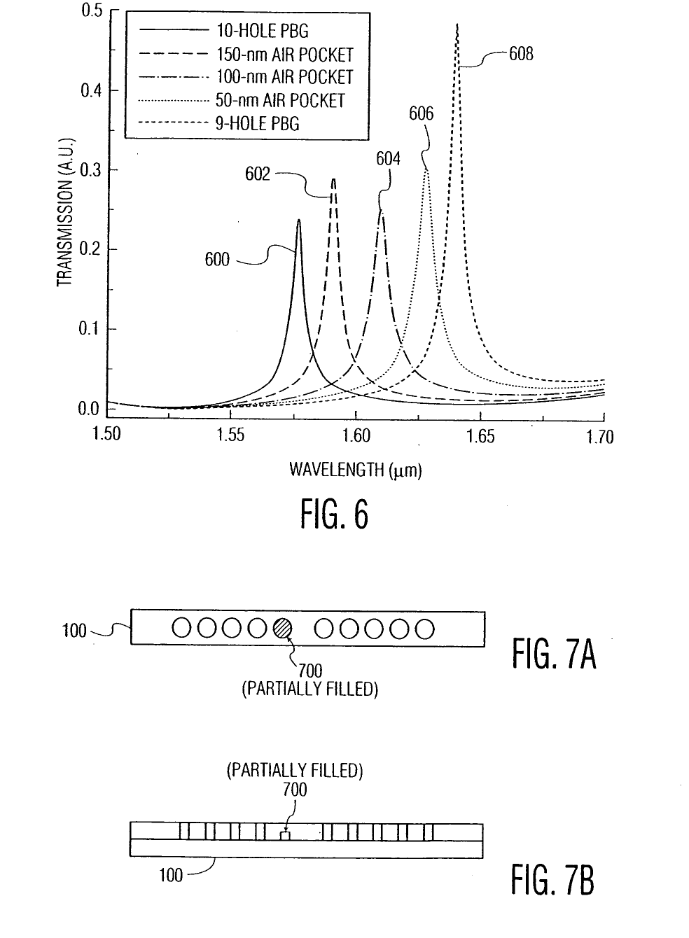

FIG. 6 illustrates numerical simulations of red-tuning an exemplary photonic crystal structure by partially filling one of the holes of the structure. FIGS. 7A and 7B illustrate exemplary 10-hole photonic crystal structure 100 with partially filled hole 700 with an air pocket, as used in the numerical simulations of FIG. 6. It is noted that, although the air pocket is shown at the bottom of partially filled hole 700 in FIG. 7B, it may be at the top instead without changing the results.

Transmission spectrum 600 is the spectrum for an untuned 10-hole photonic crystal structure. Transmission spectrum 608 is the spectrum for an untuned 9-hole photonic crystal structure, or 10-hole photonic crystal structure that has been red-tuned by completely filling one of the holes next to the defect. Transmission spectra 600 and 608 in FIG. 6 correspond to transmission spectra 210 and 212 in FIG. 2C. Transmission spectra 602, 604, and 606, show how the peak resonance wavelength may be precisely red-tuned by partially filling the predetermined hole to different degrees.

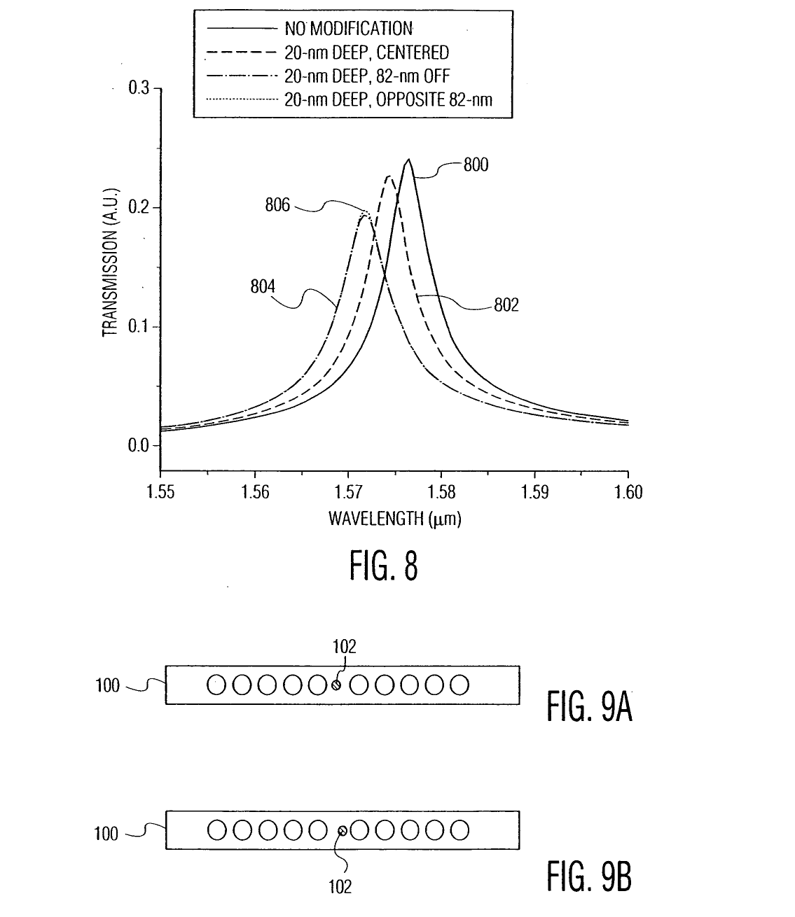

FIG. 8 illustrates numerical simulations of blue-tuning an exemplary photonic crystal structure with a tuning hole. FIGS. 9A and 9B illustrate exemplary placements of tuning hole 102 within the defect of exemplary 10-hole photonic crystal structure 100, as used in two of the numerical simulations of FIG. 8.

Transmission spectrum 800 is the spectrum for the untuned 10-hole photonic crystal structure. Transmission spectrum 802 is the spectrum for a blue-tuned 10-hole photonic crystal structure with the tuning hole centered in the defect. Transmission spectra 804 and 806, which correspond to the exemplary blue-tuned photonic crystal structures shown in FIGS. 9A and 9B, respectively, show how the peak resonance wavelength may be further blue-tuned by moving the tuning hole within the defect. As expected, the direction longitudinally along the length of the waveguide that the tuning hole is moved within the defect does not matter, only the distance that the tuning hole is moved affects the blue-tuning of the resonance frequency.

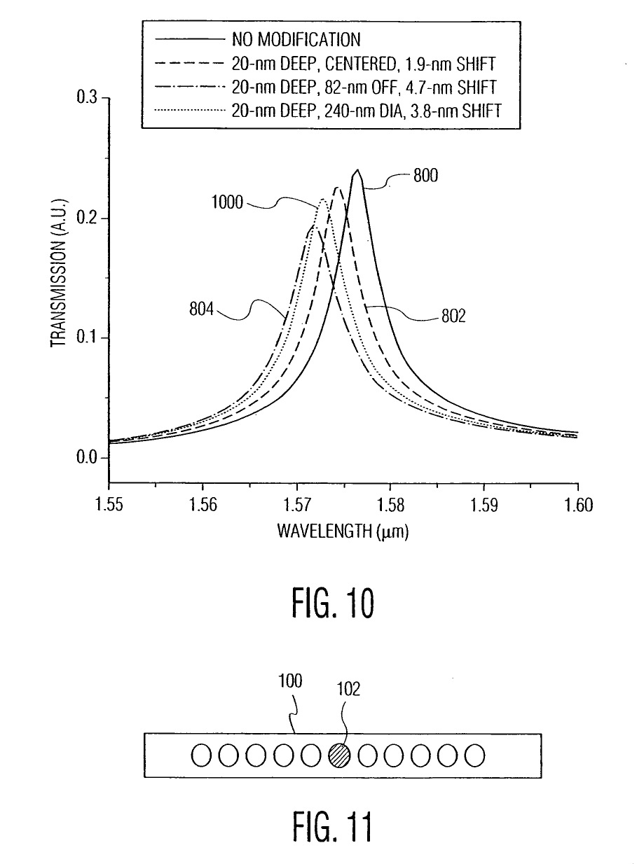

FIG. 10 illustrates additional numerical simulations of blue-tuning an exemplary photonic crystal structure with a tuning hole. FIG. 11 illustrates exemplary 10-hole photonic crystal structure 100 with tuning hole 102 place within its defect, as used in the numerical simulations of FIG. 10.

As in FIG. 8, transmission spectrum 800 is the spectrum for the untuned 10-hole photonic crystal structure. Transmission spectrum 802 is the spectrum for a blue-tuned 10-hole photonic crystal structure with a small tuning hole centered in the defect. Transmission spectrum 1000 shows how the amount of blue-tuning may be increased by increasing the size of a tuning hole centered in the defect. Transmission spectrum 804 is included to compare how the peak resonance wavelength may blue-tuned by moving the tuning hole within the defect as opposed to increasing the size of the tuning hole.

The present invention includes exemplary methods to tune the peak resonance frequency of a photonic crystal structure. Although the invention is illustrated and described herein with reference to specific embodiments, the invention is not intended to be limited to the details shown. Rather, various modifications may be made in the details within the scope and range of equivalents of the claims and without departing from the invention. In particular, it is noted that, although the specific examples and numerical simulation described herein all pertain to the tuning the resonance frequency of one dimensional photonic crystal structures, the exemplary methods of the present invention may be used equally well to tune resonance frequencies and other parameters of one, two, and three dimensional photonic crystal structures.

What is claimed:

1. A method for red-tuning the resonance frequency of a photonic crystal structure that includes a plurality of holes, using a near-field scanning optical microscope (NSOM) system, the method comprising the steps of:
a) ablating part of the photonic crystal structure using the NSOM system to form submicron scale debris on a top surface of the photonic crystal structure; and
b) using a tip of the NSOM system to move a portion of the submicron scale debris across the top surface of the photonic crystal structure to partially fill at least one predetermined hole of the plurality of holes of the photonic crystal structure.

2. The method according to claim 1, wherein step (a) includes the steps of:
a1) contacting the tip of the NSOM system on a predetermined location of the top surface of the photonic crystal structure; and
a2) coupling laser pulses from a pulsed laser source of the NSOM system through the tip of the NSOM system to ablate the part of the photonic crystal structure.

3. The method according to claim 2, wherein step (a1) includes the steps of:
a1a) locating the predetermined location of the top surface of the photonic crystal structure;
a1b) aligning the tip of the NSOM system with the predetermined location of the top surface of the photonic crystal structure in a plane approximately parallel to the top surface; and
a1c) bringing the tip of the NSOM system and the top surface of the photonic crystal structure together along a line substantially normal to the plane until the tip exerts a predetermined force on the predetermined location.

4. The method according to claim 3, wherein step (ala) includes at least one of:
profiling the top surface of the photonic crystal structure using the NSOM system to locate the predetermined location of the top surface of the photonic crystal structure; or
imaging the top surface of the photonic crystal structure using an optical camera to locate the predetermined location of the top surface of the photonic crystal structure.

5. The method according to claim 1, wherein step (b) includes the steps of:
b1) locating the submicron scale debris formed on the top surface of the photonic crystal structure in step (a); and
b2) using the tip of the NSOM system to move the portion of the submicron scale debris across the top surface of the photonic crystal structure to partially fill the at least one predetermined hole.

6. The method according to claim 5, wherein step (b1) includes at least one of:
profiling the top surface of the photonic crystal structure using the NSOM system to locate the submicron scale debris formed on the top surface of the photonic crystal structure; or
imaging the top surface of the photonic crystal structure using an optical camera to locate the submicron scale debris formed on the top surface of the photonic crystal structure.

7. The method according to claim 1, wherein step (b) includes the steps of:
b1) measuring an initial resonance frequency of the photonic crystal structure;
b2) comparing the initial resonance frequency to a desired resonance frequency range;
b3) determining a volume of the at least one predetermined hole to fill with the portion of the submicron scale debris based on the comparison of step (b2); and
b4) using the tip of the NSOM system to move the portion of the submicron scale debris across the top surface of the photonic crystal structure to fill the volume of the at least one predetermined hole determined in step (b3).

8. The method according to claim 1, wherein step (b) includes at least one of:
pushing a grain of the submicron scale debris across the top surface of the photonic crystal structure and into one of the at least one predetermined hole of the photonic crystal structure with the tip of the NSOM system; or
aligning the tip of the NSOM system with a grain of the submicron scale debris, coupling a laser beam from a laser source of the NSOM system through the tip of the NSOM system to trap the grain of the submicron scale debris, and placing the trapped grain in one of the at least one predetermined hole of the photonic crystal structure.

9. The method according to claim 1, further comprising the step of:
c) annealing the portion of the submicron scale debris partially filling the at least one predetermined hole of the plurality of holes of the photonic crystal structure.

10. The method according to claim 9, wherein step (c) includes at least one of:
heating the photonic crystal structure to temperature greater than an annealing temperature for material of the submicron scale debris; or
irradiating the portion of the submicron scale debris partially filling the at least one predetermined hole using a pulsed laser source of the NSOM system at an annealing fluence less than an ablation threshold fluence of the material of the submicron scale debris.

11. The method according to claim 1, further comprising the step of:
c) measuring a tuned resonance frequency of the red-tuned photonic crystal structure;
d) comparing the tuned resonance frequency to a desired resonance frequency range;
e) repeating steps (b), (c), (d), and (e) if the tuned resonance frequency is greater than the desired resonance frequency range; and
f) blue-tuning the photonic crystal structure and repeating steps (c), (d), (e), and (f) if the tuned resonance frequency is less than the desired resonance frequency.

12. A method for red-tuning the resonance frequency of a photonic crystal structure that includes a plurality of holes and a defect section, using a near-field scanning optical microscope (NSOM) system, the method comprising the steps of:
a) trapping nano-particles from a reservoir of nano-particles using the NSOM system; and
b) placing the trapped nano-particles:
in a predetermined hole of the plurality of holes of the photonic crystal structure to partially fill the predetermined hole; or
on the defect section of the photonic crystal structure to form a hump.

13. The method according to claim 12, wherein step (a) includes the steps of:
a1) aligning a tip of the NSOM system over the reservoir of nano-particles; and
a2) coupling a laser beam from a laser source of the NSOM system through the tip of the NSOM system to trap at least one nano-particle from the reservoir of nano-particles.

14. The method according to claim 12, wherein step (b) includes the steps of:
b1) locating the predetermined hole or the defect section of the photonic crystal structure;
b2) aligning the tip of the NSOM system with the predetermined hole or the defect section of the photonic crystal structure located in step (b1) in a plane approximately parallel to the top surface; and
b3) releasing the trapped nano-particles.

15. The method according to claim 14, wherein step (b1) includes at least one of:
profiling the top surface of the photonic crystal structure using the NSOM system to locate the predetermined hole or the defect section of the photonic crystal structure; or
imaging the top surface of the photonic crystal structure using an optical camera to locate the predetermined hole or the defect section of the photonic crystal structure.

16. The method according to claim 12, further comprising the steps of:
c) measuring an initial resonance frequency of the photonic crystal structure;
d) comparing the initial resonance frequency to a desired resonance frequency range; and
e) determining a volume of the predetermined hole to fill or the volume of the hump to form based on the comparison of step (d).

17. The method according to claim 12, further comprising the step of:
c) annealing the placed nano-particles.

18. The method according to claim 17, wherein step (c) includes at least one of:
heating the photonic crystal structure to temperature greater than an annealing temperature for material of the nano-particles; or
irradiating the placed nano-particles using a pulsed laser source of the NSOM system at an annealing fluence less than an ablation threshold fluence of the material of nano-particles.

19. The method according to claim 12, further comprising the step of:
c) measuring a tuned resonance frequency of the red-tuned photonic crystal structure;
d) comparing the tuned resonance frequency to a desired resonance frequency range;
e) repeating steps (b), (c), (d), and (e) if the tuned resonance frequency is greater than the desired resonance frequency range; and
f) blue-tuning the photonic crystal structure and repeating steps (c), (d), (e), and (f) if the tuned resonance frequency is less than the desired resonance frequency.

20. A method for red-tuning the resonance frequency of a photonic crystal structure that includes a plurality of holes, using a laser assisted chemical vapor deposition (LACVD) system, the method comprising the steps of:
a) placing the photonic crystal structure in a deposition chamber of the LACVD system;
b) aligning a beam spot of the LACVD system to be incident on a predetermined hole of the plurality of holes of the photonic crystal structure;
c) introducing a deposition vapor into the deposition chamber of the LACVD system; and
d) coupling laser radiation of the LACVD system to the beam spot on the predetermined hole of the photonic crystal structure to induce the deposition vapor to react and deposit material at the beam spot to partially fill the predetermined hole.

21. The method according to claim 20, wherein step (b) includes the steps of:
b1) imaging a top surface of the photonic crystal structure and the beam spot of the LACVD system on the top surface using an optical camera to identify an initial location of the beam spot on the top surface of the photonic crystal structure;
b2) identifying a location of the predetermined hole of the photonic crystal structure relative to the initial position of the beam spot on the top surface of the photonic crystal structure; and
b3) aligning the beam spot of the LACVD system to be incident on the predetermined hole based on the location of the predetermined hole of the photonic crystal structure relative to the initial position of the beam spot on the top surface of the photonic crystal structure.

22. The method according to claim 20, further comprising the steps of:
e) measuring an initial resonance frequency of the photonic crystal structure;
f) comparing the initial resonance frequency to a desired resonance frequency range; and
g) determining a volume of the predetermined hole to fill based on the comparison of step (f).

23. The method according to claim 20, further comprising the step of:
e) annealing the material deposited in step (d).

24. The method according to claim 23, wherein step (d) includes at least one of:
heating the photonic crystal structure to temperature greater than an annealing temperature for the material deposited in step (d); or
irradiating the material deposited in step (d) using laser radiation of the LACVD system at an annealing fluence less than an ablation threshold fluence of the material deposited in step (d) and greater than a deposition fluence used in step (d).

25. The method according to claim 20, further comprising the step of:
e) measuring a tuned resonance frequency of the red-tuned photonic crystal structure;
f) comparing the tuned resonance frequency to a desired resonance frequency range;
g) repeating steps (c), (d), (e), (f), and (g) if the tuned resonance frequency is greater than the desired resonance frequency range; and
h) blue-tuning the photonic crystal structure and repeating steps (e), (f), (g), and (h) if the tuned resonance frequency is less than the desired resonance frequency.

26. A method for red-tuning the resonance frequency of a photonic crystal structure that includes a defect, using a laser assisted chemical vapor deposition (LACVD) system, the method comprising the steps of:
a) placing the photonic crystal structure in a deposition chamber of the LACVD system;
b) aligning a beam spot of the LACVD system to be incident on a predetermined portion of the defect of the photonic crystal structure;
c) introducing a deposition vapor into the deposition chamber of the LACVD system; and
d) coupling laser radiation of the LACVD system to the beam spot on the predetermined portion of the defect of the photonic crystal structure to induce the deposition vapor to react and deposit material on the predetermined portion of the defect, thereby forming a hump on the defect.

27. The method according to claim 26, wherein step (b) includes the steps of:
b1) imaging a top surface of the photonic crystal structure and the beam spot of the LACVD system on the top surface using an optical camera to identify an initial location of the beam spot on the top surface of the photonic crystal structure;
b2) identifying the predetermined portion of the defect of the photonic crystal structure relative to the initial position of the beam spot on the top surface of the photonic crystal structure; and
b3) aligning the beam spot of the LACVD system to be incident on the predetermined portion of the defect based on the predetermined portion of the defect of the photonic crystal structure relative to the initial position of the beam spot on the top surface of the photonic crystal structure.

28. The method according to claim 26, further comprising the steps of:
e) measuring an initial resonance frequency of the photonic crystal structure;
f) comparing the initial resonance frequency to a desired resonance frequency range; and
g) determining a volume of material to deposit on the predetermined portion of the defect of the photonic crystal structure based on the comparison of step (f).

29. The method according to claim 26, further comprising the step of:
e) annealing the material deposited in step (d).

30. The method according to claim 29, wherein step (d) includes at least one of:
heating the photonic crystal structure to temperature greater than an annealing temperature for the material deposited in step (d); or
irradiating the material deposited in step (d) using laser radiation of the LACVD system at an annealing fluence less than an ablation threshold fluence of the material deposited in step (d) and greater than a deposition fluence used in step (d).

31. The method according to claim 26, further comprising the step of:
e) measuring a tuned resonance frequency of the red-tuned photonic crystal structure;
f) comparing the tuned resonance frequency to a desired resonance frequency range;
g) repeating steps (c), (d), (e), (f), and (g) if the tuned resonance frequency is greater than the desired resonance frequency range; and
h) blue-tuning the photonic crystal structure and repeating steps (e), (f), (g), and (h) if the tuned resonance frequency is less than the desired resonance frequency.

32. A method for red-tuning the resonance frequency of a photonic crystal structure that includes a plurality of holes on a top surface of the photonic crystal structure, using a near-field scanning optical microscope (NSOM) system, the method comprising the steps of:
a) locating a predetermined hole of the plurality of holes on the top surface of the photonic crystal structure;
b) aligning a tip of the NSOM system at an ablation location on the top surface of the photonic crystal structure a predetermined distance from the predetermined hole; and
c) ablating material from the ablation location on the top surface of the photonic crystal structure using the NSOM system such that a portion of the ablated material is redeposited in the predetermined hole.

33. The method according to claim 32, wherein step (a) includes at least one of:
profiling the top surface of the photonic crystal structure using the NSOM system; or
imaging the top surface of the photonic crystal structure using an optical camera.

34. The method according to claim 32, wherein step (b) includes contacting the tip of the NSOM system on the ablation location on the top surface of the photonic crystal structure.

35. The method according to claim 32, wherein step (c) includes the steps of:
c1) measuring an initial resonance frequency of the photonic crystal structure;
c2) comparing the initial resonance frequency to a desired resonance frequency range;
c3) determining a volume of the predetermined hole to fill based on the comparison of step (c2); and
c4) ablating material from the ablation location on the top surface of the photonic crystal structure using the NSOM system such that the portion of the ablated material redeposited in the predetermined hole fills the volume of the predetermined hole determined in step (c3).

36. The method according to claim 32, further comprising the step of:
d) annealing the portion of the ablated material redeposited in the predetermined hole of the plurality of holes of the photonic crystal structure.

37. The method according to claim 36, wherein step (d) includes at least one of:
heating the photonic crystal structure to temperature greater than an annealing temperature for the ablated material; or
irradiating the portion of the ablated material redeposited in the predetermined hole using a pulsed laser source of the NSOM system at an annealing fluence less than an ablation threshold fluence of the ablated material.

38. The method according to claim 32, further comprising the step of:
d) measuring a tuned resonance frequency of the red-tuned photonic crystal structure;
e) comparing the tuned resonance frequency to a desired resonance frequency range;
f) repeating steps (b), (c), (d), (e), and (f) if the tuned resonance frequency is greater than the desired resonance frequency range; and
g) blue-tuning the photonic crystal structure and repeating steps (d), (e), (f), and (g) if the tuned resonance frequency is less than the desired resonance frequency.
